(19) United States
(12) Patent Application Publication
(10) Pub. No.: US 2009/0139109 A1
(43) Pub. Date: Jun. 4, 2009

(54) Clothing dryer

(75) Inventor: Soo Won Park, Changwon (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 12/285,882

(22) Filed: Oct. 15, 2008

(30) Foreign Application Priority Data
Oct. 15, 2007 (KR) 10-2007-0103720

(51) Int. Cl. F26B 21/00

(52) U.S. Cl. 34/218

(57) ABSTRACT

Disclosed is a clothing dryer comprising a base configured to form a bottom of a main body, an exhaust duct installed in the main body and outwardly guiding hot air, a fixing member disposed at the exhaust duct and an exhaust duct bracket for fixing the exhaust duct at the base by being coupled to the fixing member. The exhaust duct bracket has an exhaust duct guide unit for receiving a shape of the fixing member disposed at the exhaust duct. Accordingly, it is capable of enhancing an assembly characteristic of the exhaust duct and of reducing a fabrication cost. And, the present invention relates to a method for mounting the exhaust duct of the clothing dryer at the base of the main body, by coupling the fixing member formed at the exhaust duct and the exhaust duct bracket formed at the base of the main body to each other. In the method, an exhaust duct guide unit for receiving a shape of the fixing member is formed at the upper surface of the exhaust duct bracket and then the fixing member and the exhaust duct bracket are coupled to each other, thus the exhaust duct is fixed at the base of the main body.

This application claims the benefit of Korean Patent Application No. 10-2007-0103720 filed on Oct. 15, 2007, which is hereby incorporated by reference for all purposes as if fully set forth herein.

### BACKGROUND OF THE INVENTION

1. Field of the Invention

The present invention relates to a clothing dryer, and particularly, to a clothing dryer having an exhaust duct fixing structure for fixing an exhaust duct outwardly guiding hot air in a drum.

2. Background of the Invention

Generally, a clothing dryer is an apparatus performing a drying operation on objects to be dried such as laundry contained in a drum by blowing hot air generated by an electric heater or a gas combustor into a drum. Currently, demand for the clothing dryer has been increasing.

In an exhausting type dryer, humid air exhausted from a drum is exhausted out of the dryer. In a condensing type dryer, humid air exhausted from the drum is condensed at a heat exchange unit to remove the moisture therefrom, and the dried air is recirculated back into the drum.

Hereafter, the exhausting type dryer will be explained. FIG. 1 is perspective view showing a main part, in which an exhaust duct is mounted in a main body of a clothing dryer in the related art and FIG. 2 is an enlarged perspective view showing “A” portion in FIG. 1.

The exhausting type dryer has been disclosed in Korean Patent Publication No. 10-2006-0016195, thus detailed description on a configuration of a main body of the exhausting type dryer will omitted.

As shown in FIG. 1, an exhaust duct 19 is installed over a base 30 so as to guide hot air in a drum (not shown) mounted in a cabinet 10 forming a main body of a clothing dryer 1 to be exhausted out.

Here, the exhaust duct 19 is not directly installed on the base 30. In order to conveniently mount the exhaust duct 19, an exhaust duct bracket 40 is installed on the base 30 and then the exhaust duct 19 is fixed at the exhaust duct bracket 40.

Here, the exhaust duct 19 can be installed to allow an exhausting operation through a left/right side, a rear side or a bottom side of the cabinet 10 according to an installation structure of a product. To this end, exhaust duct mounting holes 10a, 10b are formed at the cabinet 10.

As shown in FIG. 2, the exhaust duct bracket 40 according to the related art is formed in a “┘” shape. One end of the exhaust duct bracket 40 is fixed on an upper surface of the base 30 by two screws (S) and the other end is coupled to a fixing member 29 of the exhaust duct 19 by an additional screw (S), accordingly the exhaust duct 19 is fixed at the upper surface of the base 30.

However, the structure for fixing the exhaust duct 19 at the base 30 of the related art clothing dryer has the following problems.

The exhaust duct bracket 40 should be additionally provided so as to fix the exhaust duct 19 over the base and a plurality of screws (S) are required in a process for fixing the exhaust duct 19 at the additional exhaust duct bracket 40. Accordingly, multiple assembly processes should be performed so as to fix the exhaust duct 19 and a fabrication cost also increases.

And, in case of performing a side venting process for installing the exhaust duct at a side surface of the cabinet, the exhaust duct 19 should be fixed at the exhaust duct bracket 40 using operator's hands being put into the exhaust duct mounting holes 10a, 10b of the cabinet 10. During this process, since the operator cannot precisely see positions of the exhaust duct bracket 40 and the exhaust duct fixing member 29, it may take a lot of time to perform the assembly operation.

### SUMMARY OF THE INVENTION

Therefore, an object of the present invention is to provide a clothing dryer which is capable of reducing a fabrication cost and of simplifying an assembly process of a product by fixing an exhaust duct without an additional exhaust duct bracket.

Another object of the present invention is to provide a clothing dryer having an exhaust duct bracket provided with an exhaust duct guide unit by which an assembly process for an exhaust duct bracket and an exhaust duct can be easily performed even though an operator cannot see the exhaust duct bracket and the exhaust duct in case of a side venting manner.

Still another object of the present invention is to provide a clothing dryer in which an exhaust duct bracket and a base are integrated with each other.

To achieve these and other advantages and in accordance with the purpose of the present invention, as embodied and broadly described herein, there is provided a clothing dryer comprising a base configured to form a bottom of a main body, an exhaust duct installed in the main body and outwardly guiding hot air, a fixing member provided at the exhaust duct and an exhaust duct bracket for fixing the exhaust duct at the base by being coupled to the fixing member. The exhaust duct bracket is provided with an exhaust duct guide unit for receiving a shape of the fixing member formed at the exhaust duct.

Accordingly, it is capable of easily detecting precise positions of the exhaust duct and the exhaust duct bracket in a process for assembling the exhaust duct with the exhaust duct bracket.

Here, the exhaust duct is provided with the fixing member coupled to the exhaust duct bracket. As the fixing member is additionally formed at a lower portion of the exhaust duct, it is capable of obtaining a coupling force between the exhaust duct bracket and the exhaust duct. The exhaust duct and the exhaust duct guide unit may be assembled with each other by implementing the exhaust duct guide unit as a concave portion having a curvature same as that of an outer surface of the exhaust duct, however it may be difficult to firmly couple the exhaust duct to the exhaust duct bracket.

Meanwhile, the fixing member may be integrated with the exhaust duct, accordingly an additional fixing member need not be mounted at the exhaust duct.

The fixing member comprises a mounting portion coupled to the lower portion of the exhaust duct and a guide protrusion portion bent from the mounting portion.

Here, the mounting portion is formed to have a curved surface same as the outer surface of the lower portion of the exhaust duct, accordingly it is capable of enhancing an assembly characteristic of the fixing member and the exhaust duct.

The exhaust duct guide unit comprises first guide portions formed at both sides of a bent upper end of the exhaust duct bracket and a second guide portion protruded more than the first guide portions. As the first guide portions and the second guide portion are formed to have different shapes from each other, it is capable of preventing the fixing member from being separated from the guide unit of the exhaust duct bracket in an initial mounting process.

And, guide protrusions are formed at both sides of the guide protrusion portion. The guide protrusions are configured to be mounted on spots where the first guide portions and the second guide portion come into contact with each other or to interpose the second guide portion therebetween, preferably.

Here, it is effective that a gap between the guide protrusions is equal to a width of the second guide portion. Since the second guide portion formed between the first guide portions is protruded more than the first guide portions and the gap between the guide protrusions is equal to the width of the second guide portion, it is easy to mount the guide protrusions on the second guide portion in the assembly process.

A coupling hole is respectively formed at each of the fixing member and the exhaust duct bracket so as to couple the fixing member and the exhaust duct bracket to each other under a state that the guide protrusions are mounted on the guide unit, preferably. That is, by coupling a coupling means such as a screw into the coupling hole, it is capable of enhancing a coupling force between the exhaust duct and the exhaust duct bracket.

The exhaust duct bracket is formed in a bending manner resulting from cutting a part of the surface of the base. That is, as the exhaust duct bracket and the base are integrated with each other, the exhaust duct bracket need not be additionally fabricated, thus it is capable of reducing a fabrication cost.

It is effective that reinforcing beads are formed at a portion where the exhaust duct bracket is bent from the base. Here, it is preferable that the reinforcing beads are formed in a triangular shape, however it is not limited thereto.

The exhaust duct is put on an upper end of the exhaust duct bracket under a state that the exhaust duct bracket is bent up. However, as time elapses, the exhaust duct bracket may be inclined caused by a load of the exhaust duct. The reinforcing beads serve to prevent the exhaust duct bracket from being inclined and to maintain their original state.

And, the guide protrusions are formed in a bending manner in the guide protrusion portion. As the guide protrusions are forwardly bent from the guide protrusion portion, it is capable of easily mounting the fixing member by simply locking the guide protrusions on the exhaust duct guide unit.

The exhaust duct bracket may be implemented as a member separated from the base. That is, in case that it is difficult to form the exhaust duct bracket in the bending manner by cutting the base due to a material characteristic of the base, the exhaust duct bracket may be implemented as the additional member separated from the base and then be mounted on the base. In this case, the shape of the exhaust duct bracket is equal to that of the exhaust duct bracket integrally formed with the base.

And, the present invention relates to a method for mounting the exhaust duct of the clothing drier over the base of the main body by coupling the fixing member formed at the exhaust duct and the exhaust duct bracket formed on the base of the main body to each other. In the method, the exhaust duct guide unit for receiving a shape of the fixing member is formed at the upper surface of the exhaust duct bracket and then the fixing member and the exhaust duct bracket are coupled to each other, thus the exhaust duct of the clothing drier is fixed at a lower case of the main body.

As aforementioned, according to the present invention, the exhaust duct bracket integrated with the base is used to fix the exhaust duct of the clothing dryer, accordingly it is capable of reducing a fabrication cost and of simplifying an assembly process for the exhaust duct.

Further, according to the present invention, when using the side venting manner, even though an operator cannot see the exhaust duct bracket and the exhaust duct, it is capable of easily assembling the exhaust duct bracket and the exhaust duct with each other and of enhancing productivity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing a main part, in which an exhaust duct is mounted in a main body of a clothing dryer in the related art;

FIG. 2 is an enlarged perspective view showing “A” portion in FIG. 1;

FIG. 3 is a perspective view showing that an exhaust duct is fixed at an exhaust duct bracket mounted on a base in accordance with one exemplary embodiment of the present invention;

FIG. 4 is an enlarged perspective view showing “B” portion in FIG. 3;

FIG. 5 is a perspective view showing the exhaust duct bracket mounted on the base according to FIG. 3;

FIG. 6 is a side view showing the exhaust duct bracket according to FIG. 5;

FIG. 7 is a section view showing that a fixing member is mounted at the exhaust duct according to FIG. 3; and

FIG. 8 is a perspective view showing the fixing member according to FIG. 7.

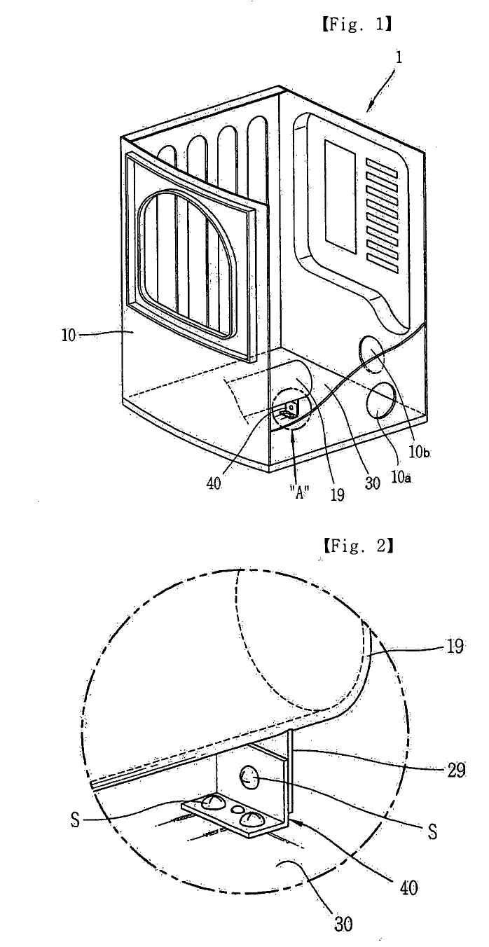

### DETAILED DESCRIPTION OF THE INVENTION

Description will now be given in detail of the present invention, with reference to the accompanying drawings. The same reference numerals are provided to the same parts of this preferred embodiment as those of other preferred embodiments, and thus their detailed explanation will be omitted.

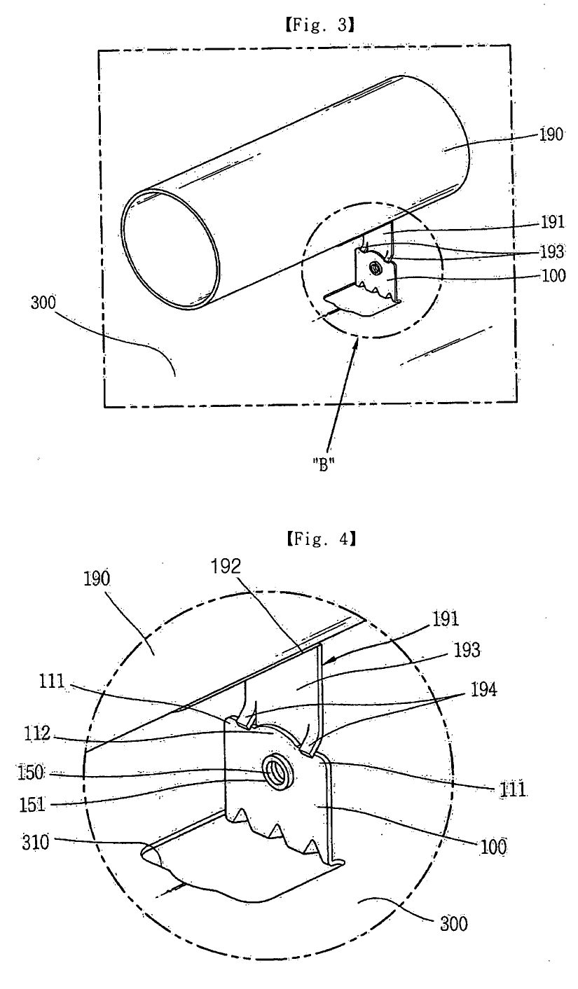

FIG. 3 is a perspective view showing that an exhaust duct is fixed at an exhaust duct bracket mounted on a base in accordance with one exemplary embodiment of the present invention and FIG. 4 is an enlarged perspective view showing “B” portion in FIG. 3.

As shown in FIGS. 3 and 4, the clothing dryer in accordance with the one embodiment of the present invention includes a base 300 implementing a bottom of a main body 10 (see FIG. 1), an exhaust duct 190 installed in the main body 10 and outwardly guiding hot air, an exhaust duct bracket 100 formed on the base 300 in a bending manner and fixing the exhaust duct 190 at the base 300. The exhaust duct bracket 100 is provided with exhaust duct guide portions 111, 112 configured to guide the exhaust duct 190 to be properly located at the exhaust duct bracket 100.

Accordingly, it is capable of easily detecting a precise assembly position for the exhaust duct 190 and the exhaust duct bracket 100 in a process for assembling the exhaust duct 190 with the exhaust duct bracket 100.

That is, even though an operator cannot see precise positions of the exhaust duct 190 and the exhaust duct bracket 100 when the exhaust duct 190 is installed at a side surface of a cabinet of the clothing dryer (i.e., side venting process), it is capable of detecting a coupling position of the exhaust duct 190 and the exhaust duct bracket 100.

Here, the exhaust duct 190 may be further provided with a fixing member 191 coupled to the exhaust duct bracket 100. By additionally forming the fixing member 191 at a lower side of the exhaust duct 190, it is capable of increasing a coupling force between the exhaust duct bracket 100 and the exhaust duct 190.

And, the exhaust duct guide portions 111, 112 are formed at an upper end of the exhaust duct bracket 100. Here, if the exhaust duct guide portions 111, 112 are concavely formed to have a curvature same as an outer surface of the lower portion of the exhaust duct 190 and the lower portion of the exhaust duct 190 is mounted in the concave portion, the exhaust duct guide portions 111, 112 may be assembled with the exhaust duct 190.

Here, if a width of the exhaust duct bracket 100 is as broad as an external diameter of the exhaust duct 190 and the exhaust duct guide portions 111, 112 are formed at the upper end of the exhaust duct bracket 100, it is capable of enhancing a mounting force of the exhaust duct 190. However, in this case, it may be difficult to firmly couple the exhaust duct bracket 100 and the exhaust duct 190 to each other comparing with a case that an additional fixing member 191 is used.

Meanwhile, the fixing member 191 may be integrated with a body of the exhaust duct 190. In this case, it is not required to additionally mounting the fixing member 191 at the exhaust duct 190. That is, if it is possible to implement the exhaust duct 190 and the fixing member 191 formed of a thermally-resistant molding material, the exhaust duct 190 and the fixing member 191 may be integrated with each other.

In case that the fixing member 191 and the exhaust duct 190 are separately formed from each other, the fixing member 191 includes a mounting portion 192 on which the outer surface of the lower portion of the exhaust duct 190 is mounted and a guide protrusion portion 193 bent from the mounting portion 192. Here, as the mounting portion 192 has a curved surface same as the outer surface of the lower portion of the exhaust duct 190, it is capable of enhancing an assembly convenience characteristic of the fixing member 191 and the exhaust duct 190. The guide protrusion portion 193 is provided with guide protrusions 194. The guide protrusions 194 are put on the exhaust duct guide portions 112, 112 of the exhaust duct bracket 100.

And, a bracket coupling hole 150 for coupling to the fixing member 191 is formed at a central portion of the exhaust duct bracket 100. And, a coupling boss 151 is protruded at a circumference of the bracket coupling hole 150 formed at the exhaust duct bracket 100 toward an opposite side of the fixing member 191.

If a coupling means is coupled to the bracket coupling hole 150 from a side that the coupling boss 151 is formed, the coupling means may be tightened and then a head of the coupling means may press the coupling boss 151. Accordingly, it is capable of preventing the coupling means from being loosened.

Hereafter, the exhaust duct bracket 100 will be explained in detail with reference to the drawings.

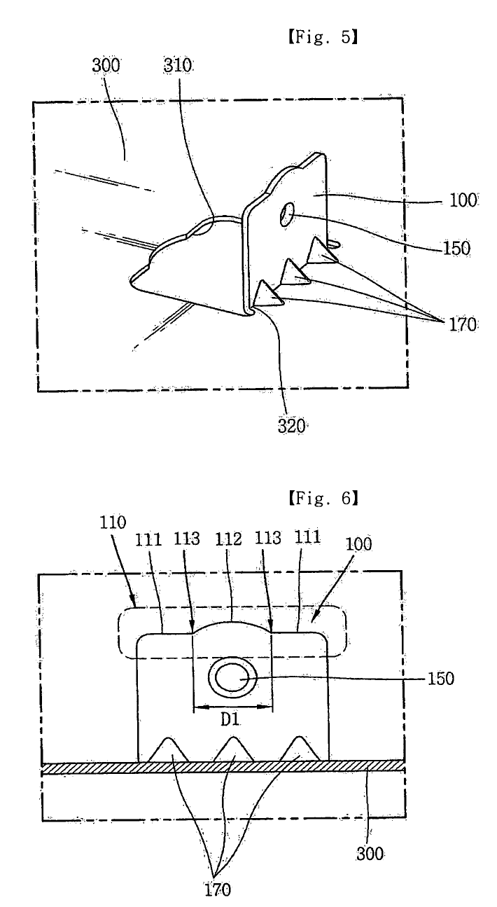

FIG. 5 is a perspective view showing the exhaust duct bracket mounted on the base according to FIG. 3 and FIG. 6 is a side view showing the exhaust duct bracket according to FIG. 5.

As shown in FIG. 5, the exhaust duct bracket 100 is formed by partially bending a base 300. That is, portions of a circumstance of the exhaust duct bracket 100 excluding a lower end of the exhaust duct bracket 100 are cut and then the exhaust duct bracket 100 is bent up by a bending process, accordingly the exhaust duct bracket 100 in accordance with the one embodiment of the present invention can be implemented.

A bracket-bent hole 310 is formed in the base 300 resulting from cutting the exhaust duct bracket 100. The bracket-bent hole 310 is larger than the exhaust duct bracket 100, preferably. If the bracket-bent hole 310 and the bracket 100 have the same or similar sizes, it may be difficult to bend the exhaust duct 100.

Since the exhaust duct bracket 100 and the base 300 are integrated with each other, the exhaust duct bracket 100 need not be additionally fabricated, thus it is capable of reducing a fabrication cost.

Meanwhile, it is effective that reinforcing beads 170 are formed at a portion where the exhaust duct bracket 100 is bent from the base 300. That is, a plurality of reinforcing parts or reinforcing beads 170 may be formed along a portion 320 where the base 300 and the exhaust duct bracket 100 are connected to each other.

Under a state that the exhaust duct bracket 100 is bent up, the exhaust duct 190 or the fixing member 191 is put on the upper end of the exhaust duct bracket 100. As time elapses, the exhaust duct bracket 100 may be inclined caused by a load of the exhaust duct 190 or an impact generated at the time of moving the clothing dryer.

As such, if the exhaust duct bracket 100 is inclined, the exhaust duct 190 may be separated from the cabinet, and accordingly air to be exhausted may be introduced into the cabinet of the clothing dryer. The reinforcing beads 170 serve to prevent the exhaust duct bracket 100 from being inclined and to maintain their original state.

Here, each reinforcing bead 170 is formed in a triangular shape or a triangular pyramid shape, preferably, however it is not limited thereto.

Referring to FIG. 6, the exhaust duct guide unit 110 includes first guide portions 111 formed at both sides of a bent upper end of the exhaust duct bracket 100 and a second guide portion 112 formed between the first guide portions 111 and protruded more than the first guide portions 111. As the first guide portions 111 and the second guide portion 112 are formed to have shapes different from each other, it is capable of the fixing member 191 from being separated from the guide unit 110 of the exhaust duct bracket 100 in a process for mounting the fixing member 191 at the exhaust duct bracket 100.

That is, if the fixing member 191 is mounted on the exhaust duct guide unit 110, the bracket coupling hole 150 formed at the exhaust duct bracket 100 and a fixing member coupling hole formed at the fixing member 191 are concentric with each other.

Here, the first guide portions 111 is formed to be flat along both upper ends of the exhaust duct bracket 100 and the second guide portion 112 is protrudingly formed in a curved surface between the first guide portions 111. Here, since the second guide portion 112 has only to be protruded more than the first guide portions 111, it can be formed in a polygonal shape as well as the curved surface.

Or, the exhaust duct guide unit 110 may be configured to obviously have spots 113 where the first guide portions 111 and the second guide portion 112 come into contact with each other. And, each curvature of the first guide portions 111 and the second guide portion 112 may be different from each other.

Hereafter, the fixing member 191 mounted on the exhaust duct guide unit 110 may be explained in detail with reference to accompanying drawings.

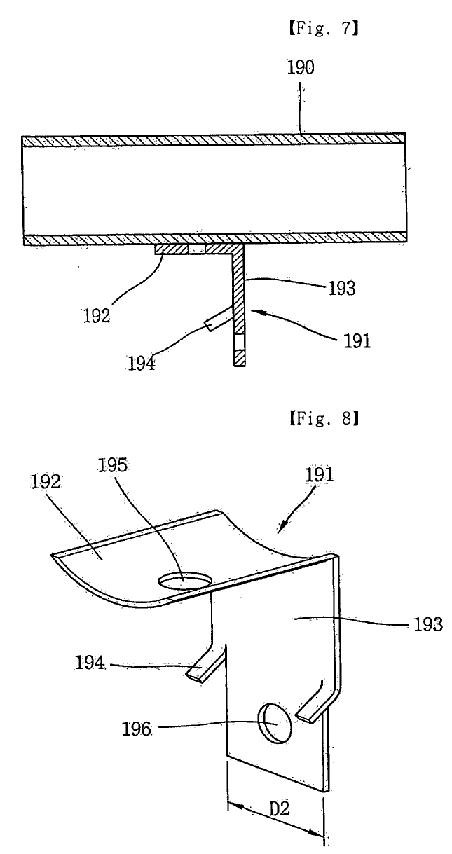

FIG. 7 is a section view showing that a fixing member is mounted at the exhaust duct according to FIG. 3 and FIG. 8 is a perspective view showing the fixing member according to FIG. 7.

Referring to FIGS. 7 and 8, the fixing member 191 includes the mounting portion 191 and the guide protrusion portion 193. The mounting portion 192 and the guide protrusion portion 193 are bent from each other.

Here, the mounting portion 192 is implemented as a concave curved surface to have a shape or a curvature same as the outer surface of the lower portion of the exhaust duct 190, preferably. The mounting portion 192 is provided with an exhaust duct coupling hole 195 to be coupled to the exhaust duct 190.

Meanwhile, guide protrusions 194 are respectively formed at both side ends of the guide protrusion portion 193 in a bent state. As the guide protrusions 194 are forwardly bent from the guide protrusion portion 193, it is capable of easily mounting the fixing member 191 by simply locking the guide protrusions 194 on the exhaust duct guide unit 110.

And, in order to couple the fixing member 191 and the exhaust duct bracket 100 to each other under a state that the guide protrusions 194 are mounted on the exhaust duct guide unit 110, a fixing member coupling hole 196 concentric with the bracket coupling hole 150 is formed in the guide protrusion portion 193. By coupling a coupling means such as a screw into the coupling holes 150, 196, it is capable of enhancing a coupling force between the exhaust duct 190 or the fixing member 191 and the exhaust duct bracket 100.

Here, the guide protrusions 194 are configured to be mounted on spots 113 (see FIG. 6) where the first guide portions 111 and the second guide portion 112 come into contact with each other or to interpose the second guide portion 112 therebetween.

Here, it is effective that a distance (D2) between the guide protrusions 194 is same as a width (D1, see FIG. 6) of the second guide portion 112 so that the guide protrusions 194 can easily detect the spots 113 where the first guide portions 111 and the second guide portion 112 come into contact with each other.

That is, as aforementioned, the second guide portion 112 formed between the first guide portions 111 is upwardly protruded more than the first guide portions 111. Here, if the distance (D2) between the guide protrusions 194 is same as the width (D1) of the second guide portion 112, it may be easy for the guide protrusions 194 to detect the spots 113 where the first guide portions 111 and the second guide portion 112 come into contact with each other in the assembly process for the exhaust duct 190 or the fixing member 191.

The exhaust duct bracket 100 may be implemented as an additional member, being separated from the base 300. That is, in case that it is difficult to form the exhaust duct bracket 100 in the bending manner by cutting the base 300 due to a material characteristic of the base 300, the exhaust duct bracket 100 may be implemented as the additional member separated from the base 300 and then be mounted on the base 300.

In this case, the shape of the exhaust duct bracket is equal to that of the exhaust duct bracket integrally formed with the base, preferably. A position decision member (not shown) may be formed on the upper surface of the base 300 so as to easily install the exhaust duct bracket and a position decision hole (not shown) may be formed in the exhaust duct bracket so as for the position decision member to be inserted thereinto.

Hereafter, a process for mounting the exhaust duct 190 will be explained in accordance with the one embodiment of the present invention.

First, the exhaust duct bracket 100 is formed on the base 300 and the fixing member 191 is mounted at the exhaust duct 190. After putting the exhaust duct 190 into the cabinet through exhaust ports (not shown) formed in the cabinet, the operator continues to operate using hands until the guide protrusions 194 detect the spots 113 where the first guide portions 111 and the second guide portion 112 come into contact with each other.

Since the second guide portion 112 is protruded, it is easy to mount the guide protrusions 194 on the spots 113 where the first guide portions 111 and the second guide portion 112 come into contact with each other.

Under a state that the guide protrusions 194 are mounted on the spots 113 where the first guide portions 111 and the second guide portion 112 come into contact with each other, the bracket coupling hole 150 and the fixing member coupling hole 196 are communicated with each other. Thus, by coupling the coupling means such as the screw into the coupling holes 150, 196, the operation for fixing the exhaust duct 190 at the base 300 is completed.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A clothing dryer comprising:
a base configured to form a bottom of a main body;
an exhaust duct installed in the main body and outwardly guiding hot air;
an exhaust duct bracket formed on the base in a bending manner so as to fix the exhaust duct at the base; and
a fixing member coupled to the exhaust duct bracket.

2. The clothing dryer of claim 1, wherein the exhaust duct bracket is provided with an exhaust duct guide unit for receiving the fixing member.

3. The clothing dryer of claim 2, wherein the fixing member comprises a mounting portion coupled to a lower portion of the exhaust duct and a guide protrusion portion bent from the mounting portion.

4. The clothing dryer of claim 3, wherein the exhaust duct guide unit comprises first guide portions formed at both sides of an upper end of the exhaust duct bracket and a second guide portion interposed between the first guide portions and protruded more than the first guide portions.

5. The clothing dryer of claim 4, wherein the first guide portions are formed to be flat along both upper ends of the exhaust duct bracket and the second guide portion is protruded in a curved surface or in a polygonal shape between the first guide portions.

6. The clothing dryer of claim 4, wherein the guide protrusion portion is configured to have guide protrusions respectively formed at spots where the first guide portions and the second guide portion come into contact with each other in both sides thereof.

7. The clothing dryer of claim 4, wherein the guide protrusion portion is configured to have guide protrusions interposing the second guide portion therebetween.

8. The clothing dryer of claim 6, wherein the guide protrusions are bent from the guide protrusion portion.

9. The clothing dryer of claim 6, wherein a coupling hole is respectively formed at each of the fixing member and the exhaust duct bracket so as to couple the fixing member and the exhaust duct bracket to each other under a state that the guide protrusions are mounted on the exhaust duct guide unit.

10. The clothing dryer of claim 1, wherein the exhaust duct bracket is bent after cutting a part of a surface of the base.

11. The clothing dryer of claim 1, wherein the exhaust duct bracket is implemented as a member separated from the base and attached onto the base.

12. The clothing dryer of claim 10, wherein reinforcing beads are formed at a portion where the exhaust duct bracket is bent from the base.
